(19) United States
(12) Patent Application Publication
(10) Pub. No.: US 2025/0126148 A1
(43) Pub. Date: Apr. 17, 2025

(54) SYSTEMS AND METHODS FOR AUTOMATED SESSION HIJACKING DETECTION AND ENTERPRISE SECURITY

(71) Applicant: DARKSAIL LLC, Austin, TX (US)

(72) Inventors: Thatcher Thornberry, Denver, CO (US); Hunter Chemelli, Austin, TX (US); Joshua D. Alexander, Austin, TX (US)

(21) Appl. No.: 18/918,023

(22) Filed: Oct. 16, 2024

Related U.S. Application Data
(60) Provisional application No. 63/590,780, filed on Oct. 16, 2023.

(51) Int. Cl. H04L 9/40

(52) U.S. Cl. CPC H04L 63/1466; H04L 63/1416; H04L 63/166

(57) ABSTRACT

Systems and methods for identifying session hijacking in computer networks and web applications. The systems/methods comprise a combination of algorithms and techniques that enable real-time detection and mitigation of unauthorized access to user sessions. The systems/methods provide a robust solution to safeguard user data and system integrity by proactively identifying and preventing session hijacking attempts. This is achieved by, first, collecting and storing TLS fingerprint components, using JA4, JA4H, and JA4L fingerprinting methods. Then the fingerprint components are analyzed and compared to previously stored fingerprint data that provide historical context to produce a context-based risk score. This risk score is provided to downstream applications for decision-making such as real-time session revoking, alerts, and security metrics.

### REFERENCE TO PRIOR-FILED APPLICATION

This application claims the benefit of U.S. Prov. Pat. App. No. 63/590,780, filed on Oct. 16, 2023, which is incorporated by reference as if set forth fully herein.

### BACKGROUND OF THE INVENTION

### Field of the Invention

The disclosure relates to enterprise security and, more particularly, systems and methods for automated session hijacking detection.

### Description of the Related Art

Session hijacking, also known as session fixation or session theft, is a prevalent cybersecurity threat in modern web applications and network environments. Unauthorized access to user sessions can lead to data breaches, identity theft, and other malicious activities. Existing solutions often fall short in detecting session hijacking effectively, warranting the need for improved methods and systems.

Traditional methods have taken advantage of a framework known as Transport Layer Security (TLS) Client Fingerprinting. TLS fingerprinting is a method used to uniquely identify devices or clients based on the characteristics of their TLS handshake. When a client (such as a web browser or application) connects to a server, it initiates a secure communication process called the TLS handshake, which involves exchanging several parameters that define how the connection will be secured. These parameters include, for example: software versioning, supported security suites, supported extensions, signature algorithms, and cryptographic information, among other things. While this process provided a robust framework to identify and block malware and botnets, different and improved solutions are warranted.

However, the recent creation of a new TLS fingerprinting suite referred to in the industry and herein as JA4 has brought renewed interest to TLS Fingerprinting, creating opportunity for many to utilize TLS Client Fingerprinting in threat detection and, more specifically, automated session hijacking detection.

A brief summary of three methods in the new JA4 suite used to provide fingerprint components is provided as these methods are important to the implementation of embodiments of the disclosure outlined herein.

JA4 Fingerprinting. This method generates a fingerprint using data collected during the TLS handshake. It focuses on several key parameters, including:
Protocol: The version of the TLS protocol used.
SNI (Server Name Indication): A value that indicates which hostname the client is trying to connect to.
Cipher suites: The cryptographic algorithms that the client supports.
Extensions: Optional extensions that add additional capabilities to the handshake.
Signature algorithms: The algorithms used for cryptographic signatures.
ALPN (Application-Layer Protocol Negotiation) extension value: This value is used to negotiate which application protocol will be used (e.g., HTTP/2 or HTTP/1.1).
   These parameters are used create a unique TLS fingerprint for each client.

JA4H Fingerprinting. This method builds upon JA4 but extends the fingerprinting process by analyzing higher-level HTTP-specific data from the client. The elements include:
HTTP Method: The type of HTTP request (e.g., GET, POST).
HTTP Version: The version of HTTP being used.
Cookies: Data stored on the client and sent with HTTP requests.
Referrer: Information about the previous web page from which the request originated.
Headers: HTTP headers that provide information about the request or the client.
Accept-Language: A header that specifies the client's language preferences.
   This provides a more detailed fingerprint based on HTTP-specific characteristics.

JA4L Fingerprinting. This method adds a focus on network-level characteristics, specifically the performance and timing data between the client and the server. The elements used in JA4L include:
Round Trip Message Duration: The time taken for a message to travel from the server to the client and back.
Packet Time to Live (TTL): A value in the packet that indicates how long the packet has been in transit across the network.
   JA4L provides insights into network behavior and can help detect differences in communication patterns between normal and potentially malicious clients.

### SUMMARY OF THE DISCLOSURE

A method and system for identifying session hijacking in computer networks and web applications, comprising a novel combination of algorithms and techniques that enable real-time detection and mitigation of unauthorized access to user sessions. Embodiments of the disclosure provide a robust solution to safeguard user data and system integrity by proactively identifying and preventing session hijacking attempts. Embodiments of the disclosure provide this solution by first collecting and storing TLS fingerprint data with the above-described JA4, JA4H, and JA4L methods, and then by analyzing new fingerprint data as it is produced. Other types of TLS fingerprint data may also be used. This analysis compares new fingerprint data to historical data and applies certain heuristics and meta-parameters to produce a “context-based risk score.” This risk score is provided to downstream applications for tactical decision making such as real-time session revoking, alerts, and security metrics.

### DETAILED DESCRIPTION OF THE INVENTION

Certain embodiments of the disclosure are described in three patterns discussed below. Though, for each pattern, the process of detecting automated session hijacking remains the same, the patterns are differentiated by their integration into existing software systems and their practical application.

Throughout this description, preferred embodiments and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

### Process of Automated Session Hijacking Detection

One embodiment of a process of automated session hijacking detection for all patterns can be also be described in three parts: collection, storage, and analysis.

Collection begins at the lowest level connection point between applications and networks for the TLS handshake process. At this level, few low-level software systems are tasked with ingesting TLS handshake packets (ClientHello, ServerHello, Finished) and facilitating the TLS handshake process between the client and server. The implementation of this invention patches one of these low-level, open-source software systems, OpenSSL, to capture the relevant details produced by the client during the TLS handshake process, calculate the JA4, JA4H, and JA4L fingerprint components, and forward this data to downstream, application-level systems.

After collection, the produced fingerprints are stored. Since data is passed downstream to the application level, storage is a simple task with many existing storage solutions at the application level such as SQL databases, key-value stores, NoSQL databases, and many other existing storage solutions. Any suitable storage mechanism may be used.

After storage, analysis begins when the produced fingerprint data is passed to the application performing the fingerprint analysis. Analysis is performed to determine if the new fingerprint, compared to its historical context, is likely an instance of session hijacking. During the analysis, first, the fingerprint is matched against a rich database of fingerprints and their associated metadata to detect if the fingerprint has previously been marked as potentially malicious. If so, the new fingerprint can be marked as an instance of session hijacking and the process returns. If not, the analysis continues.

The mechanics and meaning of fingerprint context are described herein. When a client interacts with an application protected systems/methods described herein, that client will be fingerprinted according to how the client (machine) performs the TLS handshake. From the data produced by the client during the TLS handshake, the JA4, JA4H, and JA4L (or other component) fingerprints are produced. Associated with this fingerprint is an identifier or cookie that represents the client (machine). The fingerprints are also associated with a timestamp. By associating the set of three fingerprints components with a specific client (machine) at a specific point in time and storing this data, what is referred to in this document as a “historical context” or a “fingerprint history” may be produced. This context/history is used to compare new sets of fingerprints and analyze any differences. Though disparities in new contexts compared to historical contexts may not always indicate session hijacking, it is used alongside relevant metadata and meta-parameters to determine if session hijacking is likely to have occurred.

Continuing with the analysis, after the fingerprint is found to not match against known malicious fingerprints, the fingerprint is associated with relevant metadata if it is available, such as a corresponding browser, operating system, or software library information. Then, the fingerprint is passed to a rules-based engine to determine if there is a risk due to the difference between the new fingerprint context compared to its historical context.

The rules-based engine may use TLS data, meta-parameters, metadata, and other information to determine if session hijacking has occurred.

### Graphic Web Interface (GWI) Callout Pattern

The GWI Callout Pattern as described herein involves users connecting to an application instance through Graphical Web Interface-based tools, like web browsers.

The upstream application is typically an enterprise-level application with many users, such as Salesforce or Microsoft Office, for example. The administrators of these application instances may choose few or many touch points in these applications to fingerprint a user, client, or machine. Integrating TLS Client Fingerprinting at the application level for popular, large, or legacy applications can pose challenges. Thus, the GWI Callout Pattern provides a simple drop-in mechanism to extend an application with this functionality using the ubiquitous programming language Javascript to call out to an external API that fingerprints the client device and returns that fingerprint(s) along with a calculated “Context-Based Risk Score”.

### Reverse Proxy Pattern

The Reverse Proxy Pattern involves clients connecting to an application by passing their request to a reverse proxy sitting in front of the application. The reverse proxy serves as an intermediary or “proxy” between the client and application. In this pattern, the reverse proxy is fit with a patched version of the low-level software that performs the TLS handshake. The patched code is used to create the fingerprint component(s) based on details exposed in the handshake and to forward those details to the application. The application can then use the fingerprint information to make decisions on whether or not to serve a request or take other security actions. For instance, the application could choose to infuse these fingerprints with external risk data and use that information to block the client IP address or take other security actions.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent depended from all prior claims. Combination of the various devices, components, and steps described above and in the appended claims are within the scope of this disclosure. The foregoing is intended to cover all modifications and alternative constructions falling within the spirit and scope of the invention.

We claim:

1. A system for automated session hijacking detection, comprising:
a module configured to collect client data during a Transport Layer Security (TLS) handshake process, wherein the client data includes information to generate at least one fingerprint component;
a storage system for storing the at least one generated fingerprint component alongside associated metadata and historical context;
a risk analysis engine that compares the at least one generated fingerprint component against stored historical fingerprints;
a rules-based engine configured to assign a context-based risk score based on the comparison of the at least one generated fingerprint component and the historical context; and
a decision-making module that uses the context-based risk score to trigger a security action.

2. The system of claim 1, wherein the at least one generated fingerprint component comprises one or more of a JA4 component, fingerprint a JA4H fingerprint component, and a JA4L fingerprint component.

3. The system of claim 1, wherein the collected client data comprises one or more of: protocol information, cipher suites, SNI (Server Name Indication), HTTP method, HTTP version, HTTP headers, round-trip message duration, and packet time to live.

4. The system of claim 1, wherein the storage system comprises at least one of an SQL database, a NOSQL database, or a key-value store.

5. The system of claim 1, further comprising a module for infusing new fingerprint components with metadata including browser, operating system, or software library information before risk analysis.

6. The system of claim 1, wherein the security action comprises a session revocation.

7. The system of claim 1, wherein the security action comprises an alert generation.

8. A method for automated session hijacking detection, comprising:
collecting client data during the TLS handshake to generate at least one fingerprint component;
storing the at least one generated fingerprint component;
analyzing the at least one component fingerprint against stored historical context;
assigning a context-based risk score based the at least one generated fingerprint component and the historical context;
triggering at least one security action based on the context-based risk score.

9. The method of claim 8, wherein the at least one generated fingerprint component comprises one or more of a JA4 fingerprint component, a JA4H fingerprint component, and a JA4L fingerprint component.

10. The method of claim 8, wherein the at least one security action comprises revoking a user session.

11. The method of claim 8, wherein the at least one security action comprises blocking a client IP address.

12. The method of claim 8, wherein the at least one security action comprises generating an alert.
